(19) United States
(12) Patent Application Publication
(10) Pub. No.: US 2014/0081678 A1
(43) Pub. Date: Mar. 20, 2014

(54) Rate Oscillation Monitoring Hotel Reservation System

(71) Applicant: Stephen Donald Reynolds, Dallas, TX (US)

(72) Inventor: Stephen Donald Reynolds, Dallas, TX (US)

(21) Appl. No.: 14/025,428

(22) Filed: Sep. 12, 2013

Related U.S. Application Data
(60) Provisional application No. 61/701,463, filed on Sep. 14, 2012.

(51) Int. Cl. G06Q 10/02; G06Q 50/12

(52) U.S. Cl. CPC G06Q 10/02; G06Q 50/12
USPC 705/5

(57) ABSTRACT

A system may include a processor coupled to a memory. The processor is capable of determining a hotel cluster and facilitate a first hotel reservation in response to receiving an indication that a user has selected a first hotel rate. The processor is also capable of monitoring rate oscillation and determining whether a second hotel rate is less than the first hotel rate. The processor is also capable of facilitating the second hotel reservation in response to determining that the second hotel rate is less than the first hotel rate. The processor is further capable of communicating a message to the user in response to facilitating the second hotel reservation. The processor is capable of canceling the first hotel reservation if the user has selected the second hotel reservation and canceling the second hotel reservation if the user has selected the first hotel reservation.

### RELATED APPLICATION

This application claims the benefit of priority under 35 U.S.C. §119(e) of U.S. Provisional Application 61/701,463 filed Sep. 14, 2012, which is incorporated herein by reference.

### TECHNICAL FIELD

This disclosure generally relates to the field of customer reservations and more particularly to a rate oscillation monitoring hotel reservation system.

### BACKGROUND

A hotel reservation system, which may include a hotel reservation website, may enable its users (such as persons or organizations) to interact with it. The hotel reservation system may, with input from a user, create and store hotel reservations for the user. The hotel reservation may include hotel information, reservation information, user information, and rate information. The hotel reservation system may send, over one or more networks, content or messages related to its services to a mobile or other computing device of a user. A user may also install software applications on a mobile or other computer device of the user to access data within the hotel reservation system.

### BRIEF DESCRIPTION OF THE DRAWINGS

FIG. 1 illustrates an example reservation management environment associated with a hotel reservation system.

FIG. 2 illustrates an example embodiment of a web server used in FIG. 1.

FIG. 3 illustrates an example embodiment of a website used in FIG. 1.

FIG. 4 illustrates an example embodiment of a website used in FIG. 1.

FIG. 5 illustrates an example embodiment of a website used in FIG. 1.

FIG. 6 illustrates an example embodiment of a website used in FIG. 1.

FIG. 7 illustrates an example method for managing hotel reservations using hotel rate oscillation information.

FIG. 8 illustrates an example computer system.

### DESCRIPTION OF EXAMPLE EMBODIMENTS

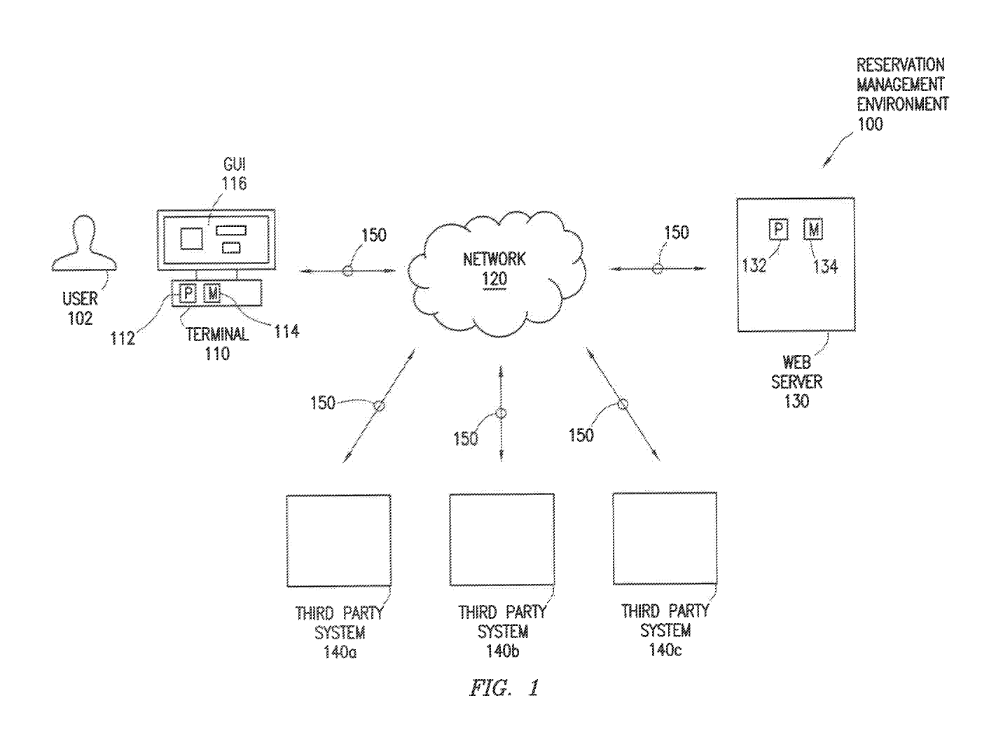

FIG. 1 illustrates an example reservation management environment 100 associated with a hotel reservation system. Reservation management environment 100 includes user 102, terminal 110, network 120, web server 130, and third party systems 140. Although FIG. 1 illustrates a particular arrangement of user 102, terminal 110, network 120, web server 130, and third party systems 140, this disclosure contemplates any suitable arrangement of user 102, terminal 110, network 120, web server 130, and third party systems 140. As an example and not by way of limitation, two or more of terminals 110, web server 130, and third party systems 140 may be connected to each other directly, bypassing network 120. As another example, two or more terminals 110, web servers 130, and third party systems 140 may be physically or logically co-located with each other in whole or in part. Moreover, although FIG. 1 illustrates a particular number of users 102, terminals 110, networks 120, web servers 130, and third party systems 140 this disclosure contemplates any suitable number of users 102, terminals 110, networks 120, web servers 130, and third party systems 140. As an example and not by way of limitation, reservation management environment may include multiple users 102, terminals 110, networks 120, web servers 130, and third party systems 140.

Generally, an enterprise may offer a variety of hotel reservation services to a particular user 102 through web server 130. User 102 may use terminal 110 to access and interact with various services provided by web server 130. For example, user 102 may enter information, using terminal 110, about a hotel reservation that user 102 desires to make. In return, web server 130 may execute a search that matches user 102's search criteria and may present a cluster of hotel results to user 102. As an example, a cluster may be any set of hotels that have been determined by web server 130 to be suitable for booking by user 102. Information that may be associated with a particular cluster may include the location of hotels, quality of hotels, brand(s) of the hotels, user ratings for the hotels, hotel amenities, and/or any other information that may be suitable for including a particular hotel in a cluster. Once a cluster has been created, user 102 may modify the cluster, choose to monitor a hotel rate, choose to book a reservation in one of the hotels presented in the cluster, or any other suitable hotel, and/or perform any other action suitable for reserving a hotel room.

In addition to clustering services, web server 130 may provide rate oscillation monitoring services to user 102. Generally, after the creation of the cluster, web server 130 may monitor hotel rates for the best rate across the hotel cluster for user 102. If user 102 has a prior reservation at a particular hotel for a particular rate, web server 130 may attempt to monitor hotel rates for the purpose of finding a better rate for user 102. Once a better rate is found, web server 130 may make a reservation at the better rate and notify user 102 of the new rate. For example, once user 102 has selected a particular reservation, web server 130 may monitor hotel rate oscillation for the particular hotel, other hotels appearing in the generated duster, and/or other similarly situated hotels. Because hotel rates may oscillate over a period of time, web server 130 may monitor hotel rates to determine when a hotel rate has fallen below a threshold rate and offer user 102 the newer, lower rate from a particular hotel, a hotel from user 102's cluster, and/or another similarly situated hotel. According to some embodiments, in response to finding a lower rate, web server 130 may make a reservation on the behalf of user 102. Web server 130 may then notify user 102 that a new reservation has been made for user 102. User 102 may then indicate to web server 130 whether web server 130 should cancel the current or prior hotel reservation for user 102. In certain embodiments, services of web server 130 may be utilized to monitor hotel rates without making a reservation for a hotel. In such an embodiment, web server 130 may communicate a notification to user 102 that a lower rate was found without facilitating the reservation of the hotel room.

Web server 130 may also provide services to hotel institutions that allow individuals associated with a particular hotel to match a desired rate set by user 102. Once a particular hotel institution is informed of a rate desired by user 102, the hotel institution may interact with components of reservation management environment 100 to indicate that the hotel will accept user 102's desired rate or make a desirable counteroffer to user 102.

More specifically, in particular embodiments, user 102 may be an individual (human user), an entity (e.g., an enterprise, business, or third party application), or a group (e.g., of individuals or entities) that interacts or communicates with or over web server 130. In particular embodiments, web server 130 may be a network-addressable computing system hosting an online hotel reservation system. Web server 130 may generate, store, receive, and send hotel reservation data, such as, for example, user information (e.g., first name, last name, address, preferences, payment information, etc.), hotel information (e.g., hotel name, hotel address, hotel amenities, hotel quality ratings, room availability, room rates, etc.), reservation information (e.g., hotel check-in time, hotel check-out time, hotel check-in date, hotel check-out date, room rate, etc.) or any other suitable data related to reservation management environment 100. Web server 130 may be accessed by the other components of reservation management environment 100 either directly or via network 120.

User 102 may use terminal 110 to interact with web server 130 or any other component of reservation management environment 100. Terminal 110 may be any device capable of providing functionality to, being operable for a particular purpose, or otherwise used by user 102 to access particular functionality of reservation management environment 100. Terminal 110 may be operable to communicate with network 120, web server 130, third party systems 140, and/or any other component of reservation management environment 100. As an example, terminal 110 may be a laptop computer, desktop computer, terminal, kiosk, personal digital assistant (PDA), cellular phone, tablet, portable media player, smart device, smart phone, or any other device capable of electronic communication.

In certain embodiments, terminal 110 used by user 102 may include one or more processors 112, one or more memories 114, one or more displays, one or more interfaces, one or more components capable of inputting data, one or more components capable of outputting data, one or more components capable of communicating with any other component of reservation management environment 100, or any other component suitable for a particular purpose. Communication may be accomplished wirelessly or via wireline and may be in the form of an e-mail, SMS text message, an instant message, a packet according to a network protocol, and/or any other suitable message format. According to certain embodiments, terminal 110 may include a unique device identifier that differentiates terminal 110 from any other terminal 110 in the example system.

in some embodiments, terminal 110 also may comprise graphical user interface (GUI) 116. GUI 116 is generally operable to tailor and filter data presented to user 102. GUI 116 may provide user 102 with an efficient and user-friendly presentation of information regarding the functionality of terminal 110. GUI 116 may comprise a plurality of displays having interactive fields, pull-down lists, and buttons operated by user 102. GUI 116 may include multiple levels of abstraction including groups and boundaries. In certain embodiments, GUI 116 may comprise a web browser. In another embodiment, GUI 116 may comprise a graphical representation of a mobile application.

This disclosure contemplates any suitable network 120. As an example and not by way of limitation, one or more portions of network 120 may include an ad hoc network, an intranet, an extranet, a virtual private network (VPN), a local area network (LAN), a wireless LAN (WLAN), a wide area network (WAN), a wireless WAN (MAN), a metropolitan area network (MAN), a portion of the Internet, a portion of the Public Switched Telephone Network (PSTN), a cellular telephone network, or a combination of two or more of these. Network 120 may include one or more networks 120.

Reservation management environment 100 may include web server 130. Generally, user 102 may use terminal 110 to interact with an enterprise that provides hotel reservation services. For example, the enterprise may provide access to a variety of data to user 102 associated with hotels and hotel reservations using web server 130. Web server 130 may store information about user 102, user 102's purchases, user 102's preferences, hotels, hotel reservations, third party data, user 102's hotel reservation transactions, or any other information suitable for a particular purpose. User 102 may use terminal 110 to access services provided by web server 130 to create, access, modify, and/or manage hotel reservations, hotel reservation searches, rate oscillation monitors and/or any other service offered by web server 130

More specifically, web server 130 may comprise processor 132 and memory 134. Processor 132 may include one or more microprocessors, controllers, or any other suitable computing devices or resources. Processor 132 may work, either alone or with components of reservation management environment 100, to provide a portion or all of the functionality of reservation management environment 100 described herein.

Processor 132 communicatively couples to memory 134. Memory 134 may take the form of volatile or non-volatile memory including, without limitation, magnetic media, optical media, Random Access Memory (RAM), Read Only Memory (ROM), removable media, or any other suitable memory component. In certain embodiments, a portion or all of memory 134 may store one or more database data structures, such as one or more structured query language (SQL) servers or relational databases.

In certain embodiments, memory 134 may be internal or external to processor 132 and may include one or more instruction caches or one or more data caches. Instructions in the instruction caches may be copies of instructions in memory 134, and the instruction caches may speed up retrieval of those instructions by processor 132. Data in the data caches may include any suitable combination of copies of data in memory 134 for instructions executing at processor 132 to operate on, the results of previous instructions executed at processor 132 for access by subsequent instructions executing at processor 132, or for writing to memory 134, and/or any other suitable data. The data caches may speed up read or write operations by processor 132.

In some embodiments, processor 132 may be configured to communicate over links 150. Communication over links 150 may request and/or send information about any suitable component of reservation management environment 100. Links 150 may connect terminal 110, web server 130, and third party systems 140 to network 120 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a portion of the internet, a portion of the PSTN, a cellular technology-based network, a satellite communications technology-based network, another link 150, or a combination of two or more such links 150. Links 150 need not necessarily be the same throughout reservation management environment 100. One or more first links 150 may differ in one or more respects from one or more second links 150.

Reservation management environment 100 also includes third party systems 140. According to some embodiments, third party systems 140 may be network-addressable computing systems that can host services provided to web server 130. Third party systems 140 may generate, store, retrieve, and send data associated with hotels, hotel reservations, hotel rates, geographical information, hotel quality ratings, hotel reviews, and/or any other data suitable for a particular purpose. Third party systems 140a, 140h, and 1400 are example third party systems 140. The services provided by third party systems 140a, 140b, and 140c may be similar, distinct, or have partial or complete overlap to each other. Although only a certain number of third party systems 140 are illustrated in FIG. 1, reservation management environment 100 is capable of accommodating any number of third party systems 140 as suitable for a particular purpose.

Certain embodiments of the present disclosure may provide some, none, or all of the following technical advantages having specific technical effects. In certain embodiments, components of reservation management environment 100 may initiate a large number of queries to a large number of data sources to continuously monitor hotel rate oscillation for a large variety of hotels, thereby allowing the efficient and potentially simultaneous determination of optimal hotel rates for a large number of users.

In another embodiment, components of reservation management environment 100 can obtain information associated with hotels, hotel rates, and transactions from a large plurality of data sources and store the information in a centralized location before receiving a request to execute an electronic transaction, thereby reducing the computation resources and bandwidth consumed by attempting to obtain such information from remote sources through a burst of requests after receiving a request to execute an electronic transaction.

In another embodiment, components of reservation management environment 100 can obtain information associated with hotels, hotel rates, and transactions from a large plurality of data sources and store the information in a centralized location, before receiving a request to present such information to a particular user, thereby reducing bandwidth and computational resources consumed by a user's terminal.

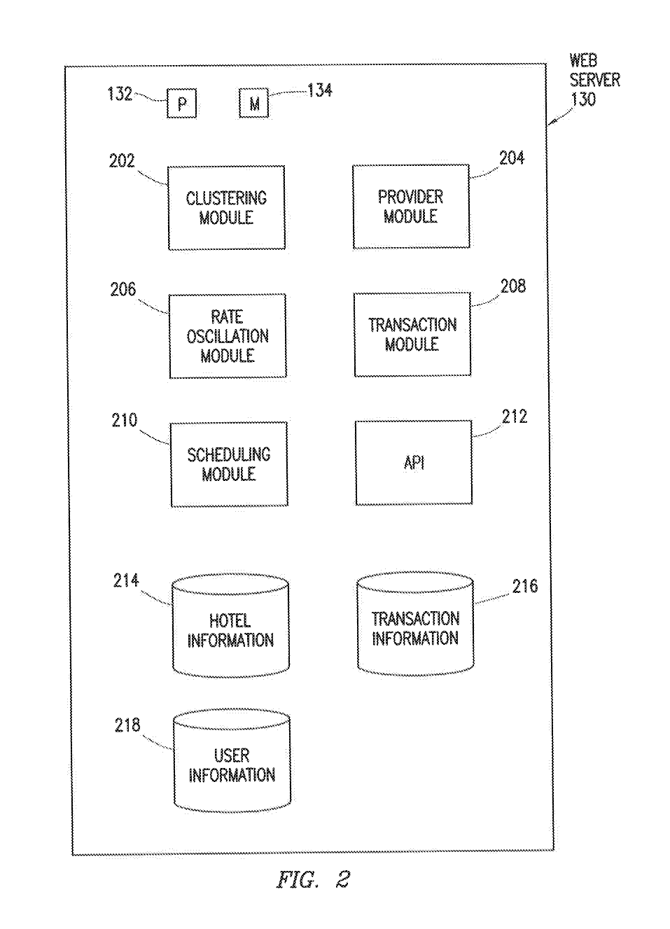

FIG. 2 illustrates an example embodiment of web server 130 used in FIG. 1. Web server 130 may include processor 132, memory 134, clustering module 202, provider module 204, rate oscillation module 206, transaction module 208, scheduling module 210, application programming interface (API) 212, hotel information 214, transaction information 216, and user information 218. Web server 130 may include hotel information 214 which contains data about hotels that may be used by any suitable component of reservation management environment 100. Generally, hotel information 214 contains information about hotels that may be presented to user 102. In particular, hotel information 214 may include data associated with one or more hotels. Hotel information 214 may contain information such as a unique hotel identifier, a hotel name, a hotel address, hotel amenities, hotel quality ratings, hotel room availability, room rates, photographs of rooms, user ratings for a hotel, hotel restrictions, reservation limitations, star ratings, loyalty program associations, and/or any other information useful for reservation management environment 100, as appropriate. In certain embodiments, hotel information 214 may be stored in one or more text files, tables in a relational database, or any other suitable data structure capable of storing information. According to some embodiments, hotel information 214 may be stored in memory 134, accessed from third party systems 140, and/or retrieved from third party systems 140 and stored in memory 134 as suitable for a particular purpose.

Web server 130 may also include transaction information 216. Generally, transaction information may contain information about transactions such as reservations that user 102 may make for a particular hotel. More specifically, transaction information 216 may include data associated with one or more transactions for one or more users 102. Transaction information 216 may contain information such a unique transaction identifier, a unique user 102 identifier, a unique hotel identifier, a hotel check-in time, a hotel check-out time, a hotel check-in date, a hotel check-out date, a room rate, room preferences, method of payment, billing address, credit card number, credit card expiration date, a base rate to beat, a savings threshold, and/or any other suitable information useful for reservation management environment 100, as appropriate. In certain embodiments, transaction information 216 may be stored in one or more text files, tables in a relational database, or any other suitable data structure capable of storing information. According to some embodiments, transaction information 216 may be stored in memory 134.

Web server 130 may also include user information 218. Generally, user information 218 contains information about users 102 that may use various services by an enterprise. In particular, user information 218 may include data associated with one or more users 102. User information 218 may contain information such as a unique user identifier, user name, user credentials, user address, email address, user preferences, payment information, hotel preferences, room preferences, amenity preferences, and/or any other information useful for reservation management environment 100, as appropriate. In certain embodiments, user information 218 may be stored in one or more text files, tables in a relational database, or any other suitable data structure capable of storing information. According to some embodiments, user information 218 may be stored in memory 134.

Web server 130 is capable of determining a hotel cluster for a particular user 102. Generally, web server 130 may include clustering module 202 which can generate various hotel clusters to present to user 102 allowing user 102 to choose a particular hotel at which user 102 may reserve a room. Clustering module 202 may generate one or more hotel clusters for each of one or more users 102. More specifically, clustering module 202 may be any software, hardware, firmware, or a combination thereof capable of determining a hotel cluster to present to user 102. For example, clustering module 202 may receive information about a particular hotel for which user 102 intends to reserve a room. In certain embodiments, this information may have been received via a website hosted by web server 130. In some embodiments, this information may have been retrieved from a reservation email forwarded to web server 130 by user 102. Based on information such as hotel information 214, transaction information 216, and/or user information 218, clustering module 202 may generate a hotel cluster. For example, clustering module 202 may determine a hotel cluster based on a hotel selected by user 102.

Clustering module 202 may select a number of hotels that share one or more similarities with the user 102 selected hotel. According to some embodiments, the hotel cluster is generated based on hotels that may share location information, quality information, brand information, hotel quality rating information, user rating information, amenities, pictures, star ratings, loyalty program associations, whether user 102 has previously booked at a particular hotel, and/or any other data suitable for a particular purpose with the user 102 selected hotel. As an example, user 102 may select a particular hotel based on that particular hotel's location and hotel quality rating. Clustering module 202 may choose a hotel cluster that includes hotels near the hotel selected by user 102 that have similar hotel quality ratings and similar hotel quality as the hotel selected by user 102. In certain embodiments, clustering module 202 may generate a hotel cluster containing one or more hotels. In such embodiments, clustering module 202 may determine a cluster of hotels that best match the preferences of user 102 and clustering module 202 may generate a grouping of hotels that may be acceptable to user 102 but may be determined to be less acceptable to user 102 than the hotel cluster. According to some embodiments, web server 130 may share a particular hotel cluster between multiple users 102. For example, user 102 may desire to save a generated hotel cluster and share it with another user 102. As another example, web server 130 may present a previously created hotel cluster to user 102. In this example, the previously created hotel cluster may have been created by web server 130, an administrator of the enterprise using functionality provided by web server 130, and/or any other third party utilizing functionality provided by web server 130.

In certain embodiments, after clustering module 202 has generated one or more hotel clusters to be displayed to user 102, clustering module 202 may further generate revised hotel clusters or altogether new clusters based on criteria received from user 102 or any other component of reservation management environment 100 as suitable for a particular purpose. For example, clustering module 202 may generate a hotel cluster which is displayed to user 102. User 102 may change a desired hotel quality rating, a desired user rating, a desired location, a desired rate, and/or any other hotel information 214, user information 218, the hotels included in the cluster, and/or transaction information 216. For example, user 102 may use terminal 110 to specify which hotel(s) should be included in the hotel cluster for user 102. In response to these changes, clustering module 202 may modify the hotel cluster or generate a new hotel cluster to be presented to user 102.

Web server 130 may also include provider module 204. Generally, provider module 204 can accept or retrieve data from third party systems 140 and process it for use within web server 130. More specifically, provider module 204 may be any software, hardware, firmware, or combination thereof capable of obtaining data from third party systems 140 and processing it to be used by web server 130. For example, provider module 204 may send a request over network 120 via link 150 to third party system 140 to obtain a particular set of data. This data may be related to hotel information 214, transaction information 216, and/or user information 218. As an example, provider module 204 may obtain data related to hotels, hotel reservations, hotel rates, geographical information, hotel quality ratings, user ratings, hotel reviews, hotel pictures, amenities offered by a hotel, and/or any other data suitable for a particular purpose in reservation management environment 100. In response, third party system 140 may communicate the requested data over network 120 via link 150 to web server 130 which may then be processed by provider module 204. In certain embodiments, provider module 204 may normalize data received from a particular third party system 140 and store it within hotel information 214, transaction information 216, user information 218, and/or any other component of reservation management environment 100 suitable for a particular purpose.

Over a period of time, hotel rates may go up or down. Generally, web server 130 may include rate oscillation module 206 which can track the movement of hotel rates either up or down. More specifically, rate oscillation module 206 may be any software, hardware, firmware, or combination thereof capable of tracking the rate oscillation of hotel room rates. For example, rate oscillation module 206 may retrieve hotel rate information for a particular hotel for a particular type of room on a particular date. Rate oscillation module may obtain this information from hotel information 214, from a third party system 140, and/or from any other component of reservation management environment 100. Rate oscillation module 206 may monitor hotel rates presented by various hotels that may be within a particular hotel cluster for a particular user 102. In certain embodiments, rate oscillation nodule may determine when a particular hotel in a particular hotel cluster for a particular user 102 is offering a hotel rate that is less than a base hotel rate that user 102 has previously booked. In such an embodiment, rate oscillation module 206 may have determined a lower rate for the same hotel that user 102 had previously booked or a different hotel within user 102's hotel cluster. According to some embodiments, rate oscillation module 206 may also be able to calculate an actual hotel rate for a particular hotel. For example, an actual hotel rate may include any cancellation fees, transactional fees, and/or any other fees that may be suitable for a particular purpose. In certain embodiments, rate oscillation module 206 may only monitor rates that are not associated with penalty rates, cancellation fees, and/or any other suitable fees and may monitor only fully refundable or flexible rates.

In some embodiments, rate oscillation module 206 may determine a particular rate for a particular hotel room within a hotel cluster for user 102 is lower than a savings threshold associated with user 102. For example, user 102 may have used terminal 110 to enter user preferences for defining a particular savings threshold. Such information may be stored in user information 218 and/or transaction information 216. Savings threshold may be a rate difference that must be exceeded for rate oscillation module 206 to determine that a particular rate is better than a previously booked rate by user 102. As an example, user 102 may set a savings threshold of ten dollars. A hotel rate obtained by rate oscillation module 206 must be at least ten dollars cheaper than the previously booked hotel rate by user 102 before rate oscillation module 206 may determine that the new rate is better than the previously obtained rate by user 102.

Once rate oscillation module 206 has determined that it has found a hotel rate that is superior to a previously hooked hotel rate by user 102, rate oscillation module may then facilitate the hooking of a hotel room at the newly determined hotel rate. Generally, web server 130 can use transaction module 208 to make hotel reservations. More specifically, transaction module 208 may be any software, hardware, firmware, or combination thereof capable of reserving a particular hotel room for a particular hotel at a particular hotel rate. In certain embodiments, transaction module 208 may use information retrieved from hotel information 214, transaction information 216, user information 218, or rate oscillation module 206 to book a particular hotel room. For example, after rate oscillation module 206 determines a rate preferable to user 102, transaction module 208 may attempt to reserve the particular hotel room at the particular rate. As another example, transaction module 208 may receive an indication that user 102 is requesting a reservation for a particular hotel room at the best available rate. Transaction module 208 may do this by sending payment information of user 102 and other user information 218 to a particular hotel to reserve the particular room. In this example, this information may be communicated to a hotel's system which may be a third party system 140. This information may be communicated over network 120 via lint 150. Third party system 140 may send confirmation or rejection of the reservation request over link 150 over network 120 to web server 130.

In certain embodiments user 102 may have two reservations or more currently pending for the same or different, hotels. In such embodiments, transaction module 208 may generate a notification to user 102 indicating to the user that user 102 has more than one hotel reservation currently pending for the same date and time. In such an embodiment, notification communicated to user 102 may be an email that may be communicated over network 120 via link 130 to user 102. The email may request user 102 to choose which hotel reservation that user 102 desires to proceed with. For example, user 102 may click a link in the email indicating to web server 130 that user 102 desires to cancel a particular hotel reservation. In certain embodiments, the email may include a link to a web page hosted by web server 130 that may allow user 102 to indicate which reservation should be canceled. In response to receiving this cancellation request over network 120 via link 150, transaction module 208 may facilitate the cancellation of a reservation at a particular hotel. Transaction module 208 may do this by communicating a cancellation request to a third party system 140 over network 120 via link 150. Although email has been used as an example, the appropriate notifications may be text messages, instant messages, and/or any other suitable form of electronic communication.

Web server 130 is capable of performing services in real time or at times according to a particular schedule. Generally, web server 130 may include scheduling module 210 which may be used to schedule the performance of a particular service at a particular time. More specifically, scheduling module 210 may be any software, hardware, firmware, or a combination thereof capable of facilitating the performance of a particular task by a web server 130. For example, scheduling module 210 may be used to monitor particular rates at a particular time. In this example, an administrator for an enterprise may determine that rate oscillation module 206 should monitor rate oscillation at a particular time of day. For example, the administrator may deem that rate oscillation module 206 performs rate oscillation monitoring at a pre-determined time every day when hotels offer updated hotel rates. The administrator may implement this monitoring schedule by using scheduling module 210. In response, scheduling module 210 will facilitate rate oscillation monitoring by rate oscillation module 206 at the desired time. Scheduling module 210 may also be used by web server 130 to interact with third party systems 140 at particular times as well. Scheduling module 210 is capable of scheduling the performance of various services such as rate oscillation monitoring one or more times a day, or as often during any particular period of time as suitable for a particular purpose.

Web server 130 may also include API 212. API 212 may allow a third party (e.g., an administrator of a hotel, a travel agent, an online travel service, a reservation service, and/or any other suitable party or service) to access various functionality of web server 130 as suitable for a particular purpose. More specifically, API 212 may be any software, hardware, firmware, or a combination thereof capable of facilitating the access of functionality provided by web server 130 to a third party. API 212 may provide access, to a third party, to listings of reservations that users 102 have made. For example, a hotel manager may access a listing of users 102 that have included the hotel manager's hotel in their hotel clusters. API 212 may provide rate information at which particular users 102 have booked hotel rooms at different hotels. The hotel manager may then use API 212 to match or beat the hotel rate accepted by a particular user 102. In certain embodiments, user 102 may specify a desired hotel rate for a particular hotel. In such an embodiment, a hotel administrator for that particular hotel may use API 212 to accept or reject the desired hotel rate for user 102. In certain embodiments, if a hotel administrator accepts a particular rate for a particular user 102, web server 130 may facilitate the transaction for reserving a particular room at the particular rate for user 102. Web server 130 may also cancel a prior reservation made by user 102, in response to creating the new reservation. API 212 may. Also be used by a third party on the behalf of user 102 utilize various functionality offered by web server 130. According to some embodiments, API 212 may allow a third party to generate a hotel cluster, perform rate oscillation monitoring, facilitate transactions, and/or initiate any other action on the behalf of a user 102 suitable for a particular purpose. As an example, the third party may use API 212 to generate a hotel cluster or perform rate oscillation monitoring, but may not desire to use web server 130 to facilitate a particular transaction. In certain embodiments, API 212 may be used by a third party to share user information 218 with web server 130. For example, this user information 218 may be used to pre-populate one or more notifications and/or web pages presented to user 102.

The operation of web server 130 may now be described with reference to FIG. 1 and FIG. 2. Generally, user 102 may use the services provided by web server 130 to reserve a hotel room at a particular rate. In certain situations, user 102 may already have a prior reservation at a certain rate before using the services provided by web server 130. The hotel rate for hotel rooms in a hotel cluster may fluctuate over time and user 102 may use web server 130 to track when hotel rates may actually drop below a certain threshold rate for one or more hotels in the hotel cluster. More specifically, in some embodiments user 102 may initiate a request to reserve a hotel room and/or monitor hotel rates across a hotel cluster by using GUI 116 on terminal 110 to access a web page that may be hosted on web server 130. For example, user 102 may use GUI 116 to input certain hotel information such as a hotel name, hotel location, and/or desired city. Terminal 110 may then communicate user 102's request over network 120 via link 150 to web server 130. In response, web server 130 may retrieve certain information. In certain embodiments, in response to receiving a request from user 102, web server 130 may retrieve user information 218, hotel information 214, transaction information 216, and/or any other information suitable for a particular purpose. Web server 130 may then use this information to generate a hotel cluster.

Web server 130 may facilitate the generation of a hotel cluster by using clustering module 202. For example, clustering module 202 may receive information associated with a particular hotel included in the request received from user 102 and may determine comparable hotels. Clustering module 202 may determine comparable hotels based on similar room rates, similar user ratings, similar hotel quality ratings, similar star ratings, loyalty program associations, similar location, similar quality, similar brand, similar amenities, and/or any other similarities suitable for a particular purpose. In certain embodiments, clustering module 202 may determine a hotel cluster based on hotels at which user 102 has previously stayed. As an example, user 102 may have chosen a particular hotel. In response, clustering module 202 may determine one or more hotels that share one or more similarities with the hotel chosen by user 102. This group of one or more hotels may be considered a hotel cluster. Clustering module 202 may also determine other hotels that also possess one or more similarities to the hotel chosen by user 102. These other hotels may not share as many similarities as hotels included in the hotel cluster generated by user 102 but may be hotels that user 102 may still inquire about. Clustering module 202 may weigh certain similarities more heavily than other similarities when determining a hotel cluster.

After web server 130 has determined a hotel cluster and has determined other hotels, web server 130 may facilitate the display of hotels to user 102. Web server 130 may do this by presenting a website that is accessed by user 102 at terminal 110. Web server 130 may also display to user 102 various options that user 102 may change to alter the hotel cluster presented to user 102. For example, web server 130 may present a web page to user 102 via GUI 116 that allows user 102 to change minimum hotel quality rating required, minimum user rating required, maximum rate, location, brand name, distance, the hotel star rating, the hotels included in the hotel cluster, and/or any other information that may be suitable for user 102 to change to facilitate the generation of an altered hotel cluster. Additionally, user 102 may input a loyalty program number.

In response to the displaying of the hotel cluster and other hotels, user 102 may use GUI 116 to alter certain settings. In certain embodiments, terminal 110 may receive input from user 102 via GUI 116 and communicate message over network 120 via link 150 to web server 130 indicating that user 102 has changed certain options. In response to receiving an indication that user 102 has changed certain options, clustering module 202 may change or alter the hotel cluster based on the received input from user 102. After user 102 has decided to select a particular hotel, user 102 may use GUI 116 to indicate that a particular hotel has been selected. In certain embodiments, terminal 110 may receive user input from user 102 via GUI 116 and may communicate a message over network 120 via link 150 to web server 130 indicating that user 102 has chosen to book a room at a particular rate at a particular hotel. In response to receiving the indication that user 102 has selected a particular hotel, web server 130 may retrieve information about that particular hotel. In certain embodiments, this information may be hotel information 214. In some embodiments, user 102 may request web server 130 to determine the best available price based on particular options selected by user 102. In response, web server 130 may retrieve pricing information for a particular hotel to offer to user 102. According to some embodiments, user 102 may instruct web server 130 to only perform rate oscillation monitoring without actually facilitating transactions.

Once information about a particular hotel has been collected by web server 130, it may be presented to user 102. According to some embodiments, web server 130 may facilitate the display of a web page hosted on web server 130 displaying hotel information 214 associated with a particular hotel selected by user 102. User 102 may access this web page via GUI 116 over network 120 via link 150. Web server 130 may also present a web page to user 102 allowing the user to use GUI 116 to input various preferences for a hotel room. For example, web server 130 may present to user 102 a particular hotel room rate that represents a threshold room rate, a savings threshold, the date of arrival, the number of adults staying in a hotel room, the number of nights user 102 is staying, the number of children accompanying user 102, a search cut-off threshold, rate options, room options, summary of the hotel room reservation, payment confirmation details, and/or any other information suitable for a particular purpose. Once user 102 has defined various preferences for hotel rates, user 102 may then communicate those preferences to web server 130. According to some embodiments, user 102 may use GUI 116 to submit hotel preferences. In response, terminal 110 may communicate the preferences of user 102 over network 120 via link 150 to web server 130. Web server 130 may then receive the preferences of user 102 and may begin to facilitate the transaction of reserving a particular hotel room at a particular rate for user 102. In certain embodiments, transaction module 208 may facilitate the reservation of a particular hotel room at a particular rate for user 102. Transaction module 208 may use hotel information 214, transaction information 216, user information 218, and/or any other information suitable for a particular purpose in order to make a reservation for a user 102.

After a reservation has been made for user 102, web server 130 may facilitate rate oscillation monitoring. In certain embodiments, user 102 may instruct web server 130 to facilitate rate oscillation monitoring without first making a reservation. More specifically, web server 130 in some embodiments may use rate oscillation module 206 to monitor hotel rate oscillation. For example, rate oscillation module 206 may use hotel information 214, transaction information 216, user information 218, and/or any other information suitable for monitoring hotel rate oscillation. As an example, in certain embodiments rate oscillation module 206 may perform rate oscillation monitoring if the current date is before a cancellation threshold. Rate oscillation module 206 may monitor hotel rates from a particular hotel or hotel rates from similarly situated hotels as the hotel that was selected by user 102 for reservations. According to some embodiments, a similarly situated hotel may be a part of a hotel cluster generated for user 102. Rate oscillation module 206 may monitor rate oscillation by retrieving hotel information 214, transaction information 216, user information 218, or any other suitable information for monitoring rate oscillation. Rate oscillation module 206 may monitor rate oscillation by retrieving hotel rates in essentially real time or at a particularly defined time. For example, scheduling module 210 may initialize rate oscillation monitoring by rate oscillation module 206 at a particular time defined by an administrator of the enterprise using reservation management environment 100. In certain embodiments, rate oscillation module 206 may obtain information from a third party system 140 over network 120 via link 150 to determine rate oscillation.

During the course of rate oscillation monitoring, rate oscillation module 206 may determine that a better rate has been found for user 102. According to some embodiments, a better rate may be defined by a rate that exceeds a certain savings threshold that was defined by user 102. As an example, if user 102 reserved a room for a base rate of $150 and set a savings threshold for $10, a better rate will be $140 or less. In some embodiments, a better rate may based on a rating threshold. For example, a better rate may be at the same rate user 102 may have previously reserved, but at a hotel with a higher quality rating, higher user rating, higher star rating, and/or any other suitable rating. Once a better rate has been found, web server 130 may facilitate the transaction of reserving the particular room at the particular rate for the particular hotel. In certain embodiments, web server 130 may use transaction module 208 to facilitate this transaction.

After web server 130 has made the reservation, web server 130 may communicate a message to user 102. This message may include a request asking user 102 to choose whether user 102 wants to accept the new rate or whether 102 desires to keep the old rate. More specifically, web server 130 may communicate a message over network 120 via link 150 to user 102. This message may be an email message, text message, instant message, and/or any other suitable electronic message sent to terminal 110. In response, user 102 may make a selection of either accepting or rejecting the new rate. In certain embodiments, the new rate may be accepted and the prior rate canceled without receiving input from user 102. If user 102 has accepted the new rate, user 102 may indicate so using terminal 110. Terminal 110 may then communicate a message over network 120 via link 150 to web server 130. After receiving an indication that user has chosen to accept the new rate, web server 130 may facilitate the transaction of cancelling the previous reservation, if user 102 has indicated that user 102 does not want to accept the new rate, then web server 130 may facilitate the transaction of cancelling the new reservation. After web server 130 has facilitated the appropriate transaction, web server 130 may continue to facilitate rate oscillation monitoring.

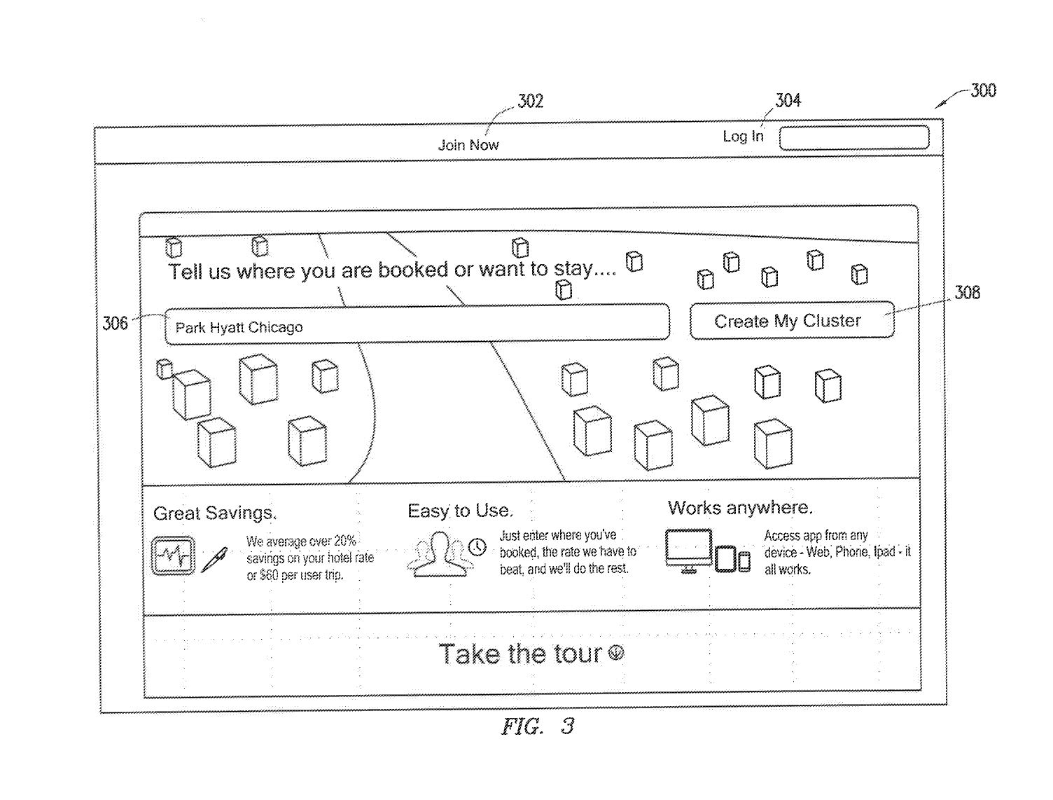

FIG. 3 illustrates an example embodiment of a website used in FIG. 1. Although FIG. 3 depicts an example website 300, other forms of delivering the contents of website 300 are contemplated. For example, website 300 may be a mobile application that is executed on a mobile device. Website 300 may contain any information that may allow user 102 to specify information to create a hotel cluster. Generally, according to some embodiments, website 300 may allow user 102 to specify details that may allow web server 130 to create a hotel cluster. More specifically, website 300 may include account creation button 302. Account creation button 302 may allow user 102 to create a customer account with an enterprise utilizing web server 130. In certain embodiments, account creation button 302 may allow user 102 to store personal information or details in user information 218. Website 300 may also include login input 304 for users 102 that may already have a user account with an enterprise utilizing web server 130. Login input 304 may take the form of one or more text boxes, one or more hypertext links, one or more buttons, one or more drop-down menus, and/or any other interface component that may allow a particular user 102 to submit information to web server 130 for authentication. In certain embodiments, after user 102 inputs information, web server 130 may authenticate user 102 by accessing user information 218.

Website 300 may also include hotel input 306. Hotel input 306 may be any interface component that may allow user 102 to specify a particular hotel or location in which user 102 is interested in making a reservation or at which user 102 has already made a reservation. In the illustrated example, hotel input 306 is a text box. Next to hotel input 306 may be creation button 308. According to some embodiments, creation button 308 may submit input entered by user 102 to be processed by web server 130. In response to receiving input from user 102, web server 130 may generate a hotel cluster for user 102.

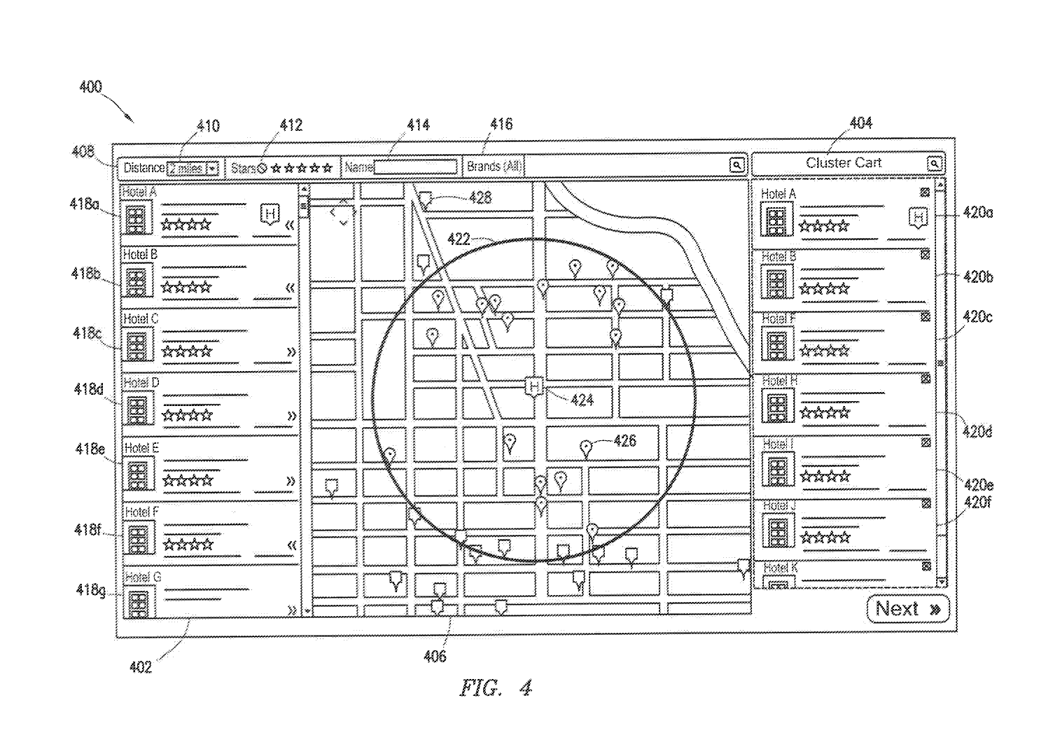

FIG. 4 illustrates an example embodiment of a website used in FIG. 1. Although FIG. 4 depicts an example website 400, other forms of delivering the contents of website 400 are contemplated. For example, website 400 may be a mobile application that is executed on a mobile device. Website 400 may contain any information that may allow user 102 to view information associated with hotels contained in a hotel cluster or other hotels, to select a particular hotel for reservation, and/or allow user 102 to change settings that may alter the generated hotel cluster. In certain embodiments, certain information presented in website 400 may be based on information received from a third party regarding user 102 via API 212.

More specifically, website 400 may include hotels pane 402. Hotels pane 402 may include information associated with particular hotels in a certain geographic area. Hotels pane 402 may include hotels 418. In the illustrated example, hotels 418a through 418g may represent distinct hotels. Hotels 418 may be hotels in a hotel cluster for user 102 or may be hotels not included in a hotel cluster for user 102. Hotels 418 may depict particular information to user 102 about particular hotels. For example, hotels 418 may include a picture, a hotel quality rating, a user rating, or any other information suitable for display to a user. Hotels 418 may include an indication to user 102 that a particular hotel 418 is included in the hotel cluster for user 102. In the illustrated example, “<<” may denote a particular hotel 418 that is in the hotel cluster for user 102 and “>>” may denote a particular hotel 418 that is not in the hotel cluster of user 102. In certain embodiments, user 102 may interact with a particular hotel 418 to add it to the hotel cluster or remove it from the hotel cluster. A particular hotel 418 may also have a visual indication to user 102 that the particular hotel 418 is the hotel that user 102 has selected for reservation. In the illustrated example, the “H” icon for hotel 418a may signify to user 102 that “Hotel A” is the selected hotel for reservation by user 102. In certain embodiments, information depicted in hotels 418 may be hotel information 214.

Website 400 may also include hotel cluster pane 404. Hotel cluster pane 404 may include information associated with hotels in the hotel cluster for user 102. Hotel cluster pane 404 may include cluster hotels 420. Cluster hotels 420 may be hotels that are included in the hotel cluster for user 102 for which user 102 may desire web server 130 to perform rate oscillation monitoring. Cluster hotels 420 may depict particular information to user 102 about particular hotels. For example, cluster hotels 420 may include a picture, a hotel quality rating, a user rating, or any other information suitable for display to a user. In certain embodiments, cluster hotels 420 may include hotel information 214. Cluster hotel 420a through 420f may represent distinct cluster hotels 420. According to some embodiments certain cluster hotels 420 included in cluster hotel pan 404 may also be hotels 418 in hotel pane 402. For example, cluster hotel 420a may represent the same hotel as hotel 418a. Cluster hotels 420 may also allow user 102 to remove a particular cluster hotel 420 from the hotel duster for user 102.

Website 400 may also display map 406. Map 406 may depict a image representing a particular geographic location. Map 406 may be a satellite image, a computer-generated image, a user-generated image, a combination thereof, and/or any other type of image suitable for displaying a particular geographical location. Map 406 may include cluster circle 422. Cluster circle 422 may visually depict to user 102 a specific area within a geographical location that includes one or more hotels in the hotel cluster for user 102. Map 406 may also include selected hotel 424. Selected hotel 424 may be a visual indication of a particular hotel on map 406 that user 102 has selected in order to reserve a room. Ire addition to selected hotel 424, map 406 may also include cluster hotel icons 426. Cluster hotel icons 426 may represent particular hotels that may be included in the hotel cluster for user 102. In certain embodiments, cluster hotel icons 426 may reference a particular cluster hotel 420 and/or a particular hotel 418. Hotel outside of the hotel cluster for user 102 may be depicted by other hotel icons 428. Other hotel icons 428 may reference hotels that may not be included in the hotel cluster for user 102. In certain embodiments, other hotel icons 428 may reference a particular hotel 418.

Website 400 may include header 408. Header 408 may include any graphical components that may allow user 102 to change preferences that user 102 may have for a hotel cluster. User 102 may change the various settings of the various components of header 408 that may alter the hotel cluster generated for user 102. For example, header 408 may include distance selector 410, minimum rating 412, hotel name 414, and brand selector 416. Distance selector 410 may be any graphical component that allows user 102 to specify a particular distance away from the selected hotel represented by selected hotel 424 for which web server 130 may include in the generation of a hotel cluster or listing of other hotels. Similarly, user 102 may user minimum rating 412 to alter which hotels are displayed in website 400, included in a generated hotel cluster, and/or included in a listing of other hotels. Minimum rating 412 may refer to a hotel quality rating, user ratings for hotels, or any other rating that may be given to a particular hotel. User 102 may input text into hotel, name 414 in order to search for a particular hotel. Header 408 may include brand selector 416 which may allow user 102 to limit the displayed hotels to a particular brand of hotels. In certain embodiments, information depicted in website 400 may be stored as hotel information 214, transaction information 216, and/or user information 218.

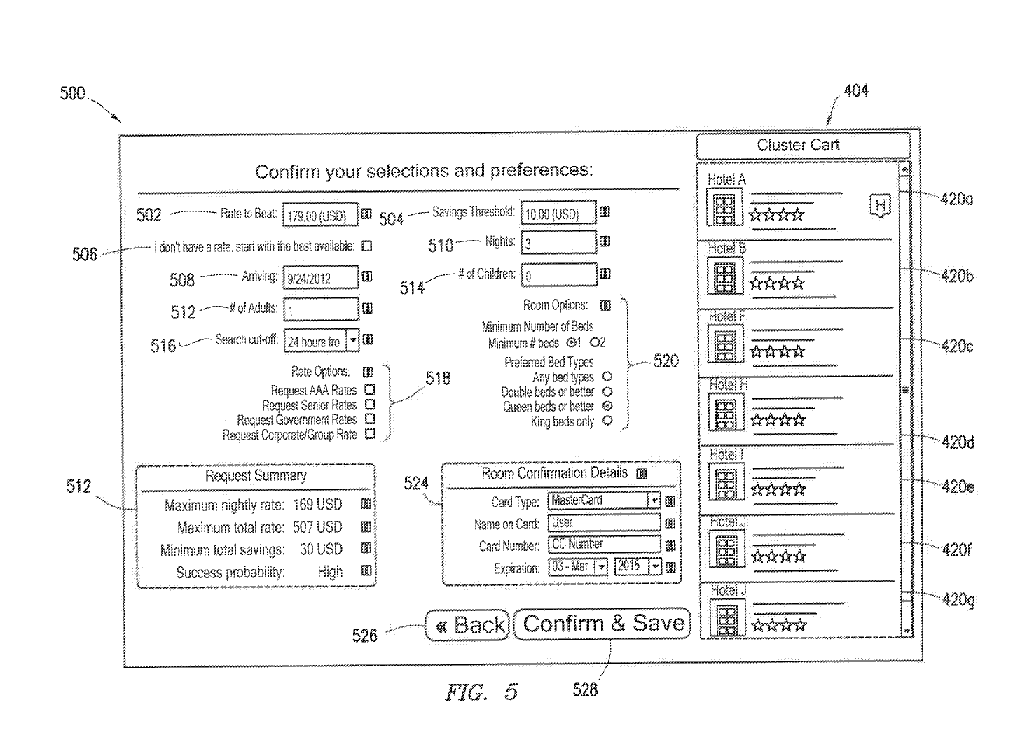

FIG. 5 illustrates an example embodiment of a website used in FIG. 1. Although. FIG. 5 depicts an example website 500, other forms of delivering the contents of website 500 are contemplated. For example, website 500 may be a mobile application that is executed on a mobile device. Website 500 may contain any information that may allow user 102 to view information associated with a hotel that allows user 102 to make a reservation. Website 500 may also contain information that can be altered by user 102 to set user preferences for monitoring rate oscillation. In certain embodiments, certain information presented in website 500 may be based on information received from a third party regarding user 102 via API 212.

More specifically, website 500 may include base rate 502. Base rate 502 may be a monetary value that represents a particular hotel rate at which user 102 may be able to reserve a particular hotel room. Base rate 502 may also represent a monetary value that may be used by rate oscillation module 206 for monitoring rate oscillation. For example, rate oscillation module 206 may facilitate the reservation for a particular hotel room at a particular rate if the particular rate is less than base rate 502. In certain embodiments, rate oscillation module 206 will facilitate the reservation for a particular hotel room at a particular rate only if the particular rate is less than a base rate 502 by a value greater than a savings threshold. User 102 may input a savings threshold in savings threshold input 504 in website 500. Website 500 may also include best available rate 506. Best available rate 506 may be any graphical component that allows user 102 to indicate to web server 130 that user 102 is requesting web server 130 to find the best available rate for a particular hotel room. In certain embodiments, web server 130 may do this by utilizing provider module 204, hotel information 214, transaction information 216, user information 218, and/or any other suitable component of reservation management environment 100.

Website 500 may include graphical components that allow user 102 to specify details about a particular desired hotel reservation. For example, website 500 may include arrival input 508 which indicates what date user 102 intends to arrive at a particular hotel. Website 500 may include nights input 510 which may indicate how many nights user 102 intends to stay at a particular hotel. Adults input 512 may indicate how many adults will occupy the particular hotel room. Similarly, children input 514 may indicate how many children will occupy the particular room.

Website 500 may also include cut-off input 516. Cut-off input 516 may allow user 102 to specify a cancellation threshold to be used by web server 130 in performing various services. For example, if the current date is after the time period specified by user 102 as the cancellation cut-off, then web server 130 may no longer perform rate oscillation monitoring for that particular reservation. Website 513 may also include rate options 518 which specify options to select special rates from a hotel as well as room options 520 which specify options to select requests for particular options for a hotel room. User 102 may input payment information into payment input 524. Back button 526 may allow user 102 to return to a previous website hosted by web server 130. Confirm button 528 may indicate to web server 130 that user 102 is submitting data for processing and/or storage. In certain embodiments, data depicted in website 500 may be saved as hotel information 214, transaction information 216, and/or user information 218. Website 500 may also include hotel cluster pane 404 which includes cluster hotels 420. Hotel cluster pane 404 may perform essentially the same functions as hotel cluster pane 404 described in FIG. 4.

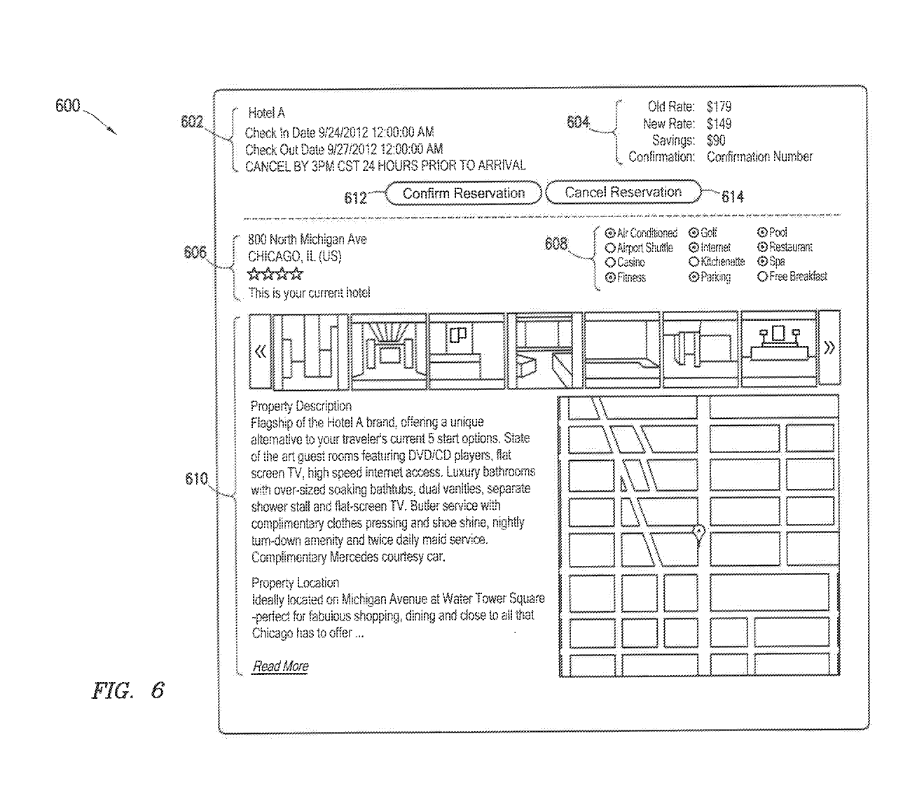

FIG. 6 illustrates an example embodiment of a website used in FIG. 1. Although FIG. 6 depicts an example website 600, other forms of delivering the contents of website 600 are contemplated. For example, website 600 may be a mobile application that is executed on a mobile device. In certain embodiments, website 600 may be an email message communicated to user 102. According to some embodiments, web server 130 may communicate an email message to user 102, the email message including a link to website 600. Website 600 may contain any information that may allow user 102 to view information associated with a particular hotel that allows user 102 to make a reservation. More specifically, website 600 may be information presented to user 102 after web server 130 has located a lower rate for a particular hotel room that meets the preferences set by user 102. Website 600 may include reservation information 602. Reservation information 602 may present information related to a proposed hotel reservation to user 102. Hotel reservation 602 may refer to a reservation that user 102 previously made, a reservation made on the behalf of user 102 by web server 130 as a result of rate oscillation monitoring, or any other suitable hotel reservation. Also depicted is rate information 604. Rate information 604 may include information that indicates to user 102 the difference between a previous reservation and the current proposed reservation. Confirmation button 612 may allow user 102 to confirm reservation and/or rate oscillation monitoring for a hotel room selected by web server 130. In certain embodiments, if user 102 selects confirmation button 612, web server 130 may cancel a previously made reservation by user 102. Website 600 may also include cancellation button 614 which allows user 102 to indicate to web server 130 that user 102 wishes to keep a previously made reservation over the current proposed reservation. In certain embodiments, in response to user 102 selecting cancellation button 614, web server 130 may cancel the proposed reservation.

Website 600 includes additional graphical components that provide user 102 with information about the reservation proposed by web server 130. For example, website 600 includes property information 610 which displays images, property information, map information, and/or an other suitable information associated with the proposed hotel reservation. In certain embodiments, information associated with website 600 may include hotel information 214, transaction information 216, and/or user information 218.

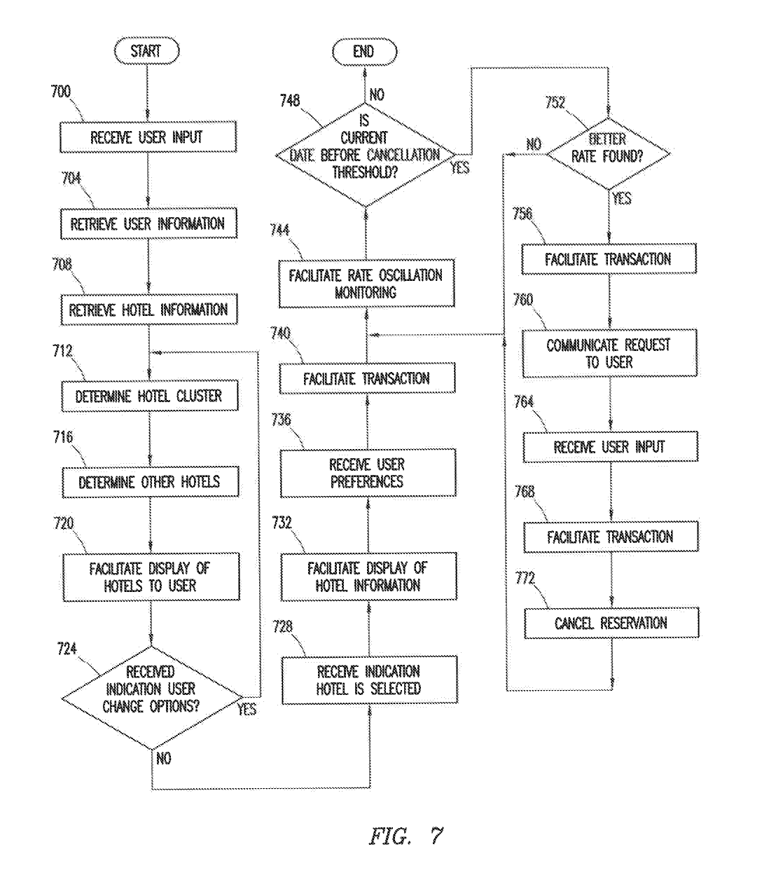

FIG. 7 illustrates an example method for managing hotel reservations using hotel rate oscillation information. The example method of FIG. 7 may be performed by the example reservation management environment 100 of FIG. 1 according to certain embodiments of the present disclosure. The method may be implemented in any suitable combination of software, firmware, and hardware. Although particular components may be identified as performing particular steps, the present disclosure contemplates any suitable components performing the steps according to particular needs.

At step 700, user 102 may initiate a request to reserve a hotel room by using GUI 116 on terminal 110 to access a web page that may be hosted on web server 130. For example, user 102 may use GUI 116 to input certain hotel information such as a hotel name, hotel location, and/or desired city. Terminal 110 may then communicate user 102's user input and request over network 120 via link 150 to web server 130. In certain embodiments, a third party may provide this information on the behalf of user 102 using API 212. In response, at step 704, web server 130 may retrieve user information 704. Additionally, at step 706, web server 130 may retrieve hotel information.

Web server 130 may then use this information to determine to hotel cluster at step 712. Web server 130 may facilitate the generation of a hotel cluster by using clustering module 202. For example, clustering module 202 may receive information associated with a particular hotel included in the request received from user 102 and may determine comparable hotels. Clustering module 202 may determine comparable hotels based on similar room rates, similar user ratings, similar hotel quality ratings, similar location, similar quality, similar brand, similar amenities, and/or any other similarities suitable for a particular purpose. As an example, user 102 may have chosen a particular hotel, in response, clustering module 202 may determine one or more hotels that share one or more similarities with the hotel chosen by user 102. This group of one or more hotels may be considered a hotel cluster. At step 716, clustering module 202 may also determine other hotels that also possess one or more similarities to the hotel chosen by user 102. These other hotels may not share as many similarities as hotels included in the hotel cluster generated by user 102 but may be hotels that user 102 may still inquire about. Clustering module 202 may weigh certain similarities more heavily than other similarities when determining a hotel cluster.

At step 720, after web server 130 has determined a hotel cluster and has determined other hotels, web server 130 may facilitate the display of hotels to user 102. Web server 130 may do this by presenting a website that is accessed by user 102 at terminal 110. Web server 130 may also display to user 102 various options that user 102 may change to alter the hotel cluster presented to user 102. For example, web server 130 may present a web page to user 102 via GUI 116 that allows user 102 to change minimum hotel quality rating required, minimum user rating required, maximum rate, location, brand name, distance, and/or any other information that may be suitable for user 102 to change to facilitate the generation of an altered hotel cluster.

In response to seeing the display of the hotel cluster and other hotels, user 102 may use GUI 116 to alter certain settings. In certain embodiments, terminal 110 may receive input from user 102 via GUI 116 and communicate message over network 120 via link 150 to web server 130 indicating that user 102 has changed certain options. If web server 130 has received an indication that user 102 has changed options that may alter the hotel cluster, the example method may proceed to step 712 to alter the hotel cluster for user 102. Otherwise, the example method may proceed to step 728.

At step 728, after user 102 has decided to select a particular hotel, user 102 may use GUI 116 to indicate that a particular hotel has been selected. In certain embodiments, terminal 110 may receive user input from user 102 via GUI 116 and may communicate a message over network 120 via link 150 to web server 130 indicating that user 102 has chosen to hook a room at a particular rate at a particular hotel. In response to receiving the indication that user 102 has selected a particular hotel, web server 130 may retrieve information about that particular hotel. In certain embodiments, this information may be hotel information 214. In some embodiments, user 102 may request web server 130 to determine the best available price based on particular options selected by user 102, in response, web server 130 may retrieve pricing information for a particular hotel to offer to user 102.

Once information about a particular hotel has been collected by web server 130, it may be presented to user 102 at step 732. According to some embodiments, web server 130 may facilitate the display of a web page hosted on web server 130 displaying hotel information 214 associated with a particular hotel selected by user 102. User 102 may access this web page via GUI 116 over network 120 via link 150. Web server 130 may also present a web page to user 102 allowing the user to use GUI 116 to input various preferences for a hotel room. For example, web server 130 may present to user 102 a particular hotel room rate that represents a threshold room rate, a savings threshold, the date of arrival, the number of adults staying in a hotel room, the number of nights user 102 is staying, the number of children accompanying user 102, a search cut-off threshold, rate options, room options, summary of the hotel room reservation, payment confirmation details, and/or any other information suitable for a particular purpose. Once user 102 has defined various preferences for hotel rates, user 102 may then communicate those preferences to web server 130. According to some embodiments, user 102 may use GUI 116 to submit hotel preferences. In response, terminal 110 may communicate the preferences of user 102 over network 120 via link 150 to web server 130.

At step 736, web server 130 may then receive the preferences of user 102. At step 740, web server 130 may begin to facilitate the transaction of reserving a particular hotel room at a particular rate for user 102. In certain embodiments, transaction module 208 may facilitate the reservation of a particular hotel room at a particular rate for user 102. Transaction module 208 may use hotel information 214, transaction information 216, user information 218, and/or any other information suitable for a particular purpose in order to make a reservation for a user 102.

After a reservation has been made for user 102, at step 744, web server 130 may facilitate rate oscillation monitoring. More specifically, web server 130 in some embodiments may use rate oscillation module 206 to monitor hotel rate oscillation. For example, rate oscillation module 206 may use hotel information 214, transaction information 216, user information 218 and/or any other information suitable for monitoring hotel rate oscillation. As an example, in certain embodiments rate oscillation module 206 may perform rate oscillation monitoring if the current date is before a cancellation threshold. Rate oscillation module 206 may monitor hotel rates from a particular hotel or hotel rates from similarly situated hotels as the hotel that was selected by user 102 for reservations. According to some embodiments, a similarly situated hotel may be a part of a hotel cluster generated for user 102. Rate oscillation module 206 may monitor rate oscillation by retrieving hotel information 214, transaction information 216, user information 218, or any other suitable information for monitoring rate oscillation. Rate oscillation module 206 may monitor rate oscillation by retrieving hotel rates in essentially real time or at a particularly defined time. For example, scheduling module 210 may initialize rate oscillation monitoring by rate oscillation module 206 at a particular time defined by an administrator of the enterprise using reservation management environment 100. In certain embodiments, rate oscillation module 206 may obtain information from a third party system 140 over network 120 via link 150 to determine rate oscillation.

At step 748, rate oscillation module 206 may determine whether the current date is beyond a cancellation threshold. For example, the cancellation threshold may be twenty-four hours prior to a check-in at a hotel. If the current date and time is beyond the cancellation threshold, the example method may end. Otherwise, rate oscillation monitoring module 206 may continue to monitor rate oscillation and proceed to step 752.

At step 752, during the course of rate oscillation monitoring, rate oscillation module 206 may determine that a better rate has been found for user 102. According to some embodiments, a better rate may be defined by a rate that exceeds a certain savings threshold that was defined by user 102. As an example, if user 102 reserved a room for a base rate of $150 and set a savings threshold for $10, a better rate will be $140 or less. If a better rate has been found, the example method may proceed to step 756. Otherwise, the example method may return to step 744.

At step 756, once a better rate has been found, web server 130 may facilitate the transaction of reserving the particular room at the particular rate for the particular hotel. In certain embodiments, web server 130 may use transaction module 208 to facilitate this transaction.

After web server 130 has made the reservation, at step 760, web server 130 may communicate a message to user 102. This message may include a request asking user 102 to accept the new rate or keep the old rate. More specifically, web server 130 may communicate a message over network 120 via link 150 to user 102. In certain embodiments, this message may be an email message sent to terminal 110. In response, user 102 may make a selection of either accepting or rejecting the new rate. Terminal 110 may then communicate a message over network 120 via link 150 to web server 130 indicating the selection of user 102. At step 764, web server 130 may receive an indication of the selection by user 120.

At step 768, web server 130 may facilitate the appropriate transaction. After receiving an indication that user has chosen to accept the new rate, at step 772, web server 130 may facilitate the transaction of cancelling the previous reservation, if user 102 has indicated that user 102 does not want to accept the new rate, then web server 130 may facilitate the transaction of cancelling the new reservation. After web server 130 has facilitated the appropriate transaction, web server 130 may continue to facilitate rate oscillation monitoring at step 744.

Although the present disclosure describes or illustrates particular operations as occurring in a particular order, the present disclosure contemplates any suitable operations occurring in any suitable order. Moreover, the present disclosure contemplates any suitable operations being repeated one or more times in any suitable order. Although the present disclosure describes or illustrates particular operations as occurring in sequence, the present disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

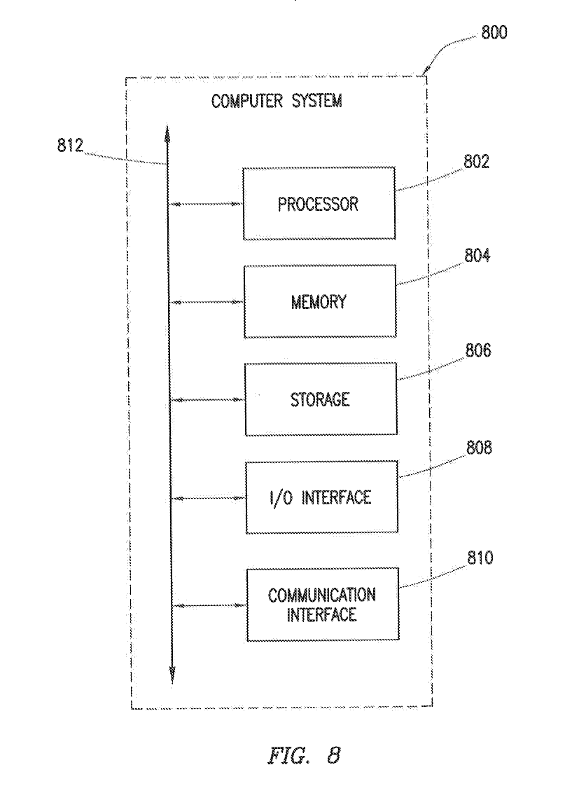

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLIIs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate. I/O interface 808 may include one or more device or software drivers enabling processor 802 to drive one or more of these I/O devices. I/O interface 808 may include one or more I/O interfaces 808, where appropriate. Although this disclosure describes and illustrates a particular interface, this disclosure contemplates any suitable I/O interface.

In particular embodiments, communication interface 810 includes hardware, software, or bath providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WAN) (such as, for example, a BLUETOOTH WPAN) a network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced. Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A system comprising:
a memory operable to store hotel information; and
a processor communicatively couple to the memory, and operable to:
receive a first indication that a user has selected a first hotel;
determine a hotel duster based at least in part upon the first hotel and hotel information;
receive a second indication that the user has selected a first hotel rate;
facilitate a first hotel reservation in response to receiving the second indication;
monitor rate oscillation based at least in part upon the first hotel rate;
determine whether a second hotel rate is less than the first hotel rate;
facilitate a second hotel reservation in response to determining that the second hotel rate is less than the first hotel rate;
communicate a message to the user in response to facilitating the second hotel reservation, the message containing a request to choose one of the first hotel reservation and the second hotel reservation;
cancel the first hotel reservation in response to determining that the user has selected the second hotel reservation; and
cancel the second hotel reservation in response to determining that the user has selected the first hotel reservation.

2. The system of claim 1, wherein determining the hotel cluster comprises:
determining a geographical location of the first hotel;
determining a hotel quality rating of the first hotel; and
determining at least one hotel based at least in part upon the geographical location and the hotel quality rating.

3. The system of claim 1, wherein the processor is further operable to cease rate oscillation monitoring if the cancellation threshold has been exceeded.

4. The system of claim 1, wherein monitoring rate oscillation comprises retrieving a plurality of hotel rates based at least in part upon the hotel duster.

5. The system of claim 4, wherein the plurality of hotel rates are retrieved at a predetermined time.

6. The system of claim 1, wherein determining whether the second hotel rate is less than the first hotel rate comprises determining whether the difference between the second hotel rate and the first hotel rate is greater than a savings threshold.

7. The system of claim 1, wherein the processor is further operable to:
receive a third indication that the user has selected a hotel option; and
alter the hotel cluster based at least in part upon the hotel option.

8. A computer-implemented method, comprising:
storing, using a processor, hotel information;
receiving, using the processor, a first indication that a user has selected a first hotel;
determining, using the processor, a hotel cluster based at least in part upon the first hotel and hotel information;
receiving, using the processor, a second indication that the user has selected a first hotel rate;
facilitating, using the processor, a first hotel reservation in response to receiving the second indication;
monitoring, using the processor, rate oscillation based at least in part upon the first hotel rate;
determining, using the processor, whether a second hotel rate is less than the first hotel rate;
facilitating, using the processor, a second hotel reservation in response to determining that the second hotel rate is less than the first hotel rate;
communicating, using the processor, a message to the user in response to facilitating the second hotel reservation, the message containing a request to choose one of the first hotel reservation and the second hotel reservation;
canceling, using the processor, the first hotel reservation in response to determining that the user has selected the second hotel reservation; and
canceling, using the processor, the second hotel reservation in response to determining that the user has selected the first hotel reservation.

9. The method of claim 8, wherein determining the hotel cluster comprises:
determining a geographical location of the first hotel;
determining a hotel quality rating of the first hotel; and
determining at least one hotel based at least in part upon the geographical location and the hotel quality rating.

10. The method of claim 8, further comprising ceasing rate oscillation monitoring if the cancellation threshold has been exceeded

11. The method of claim 8, wherein monitoring rate oscillation comprises retrieving a plurality of hotel rates based at least in part upon the hotel cluster.

12. The method of claim 11, wherein the plurality of hotel rates are retrieved at a predetermined time.

13. The method of claim 8, wherein determining whether the second hotel rate is less than the first hotel rate comprises determining whether the difference between the second hotel rate and the first hotel rate is greater than a savings threshold.

14. The method of claim 8, further comprising:
receiving a third indication that the user has selected a hotel option; and
altering the hotel cluster based at least in part upon the hotel option.

15. A web server, comprising a processor, operable to:
store hotel information; and
receive a first indication that a user has selected a first hotel;
determine a hotel cluster based at least in part upon the first hotel and hotel information;
receive a second indication that the user has selected a first hotel rate;
facilitate a first hotel reservation in response to receiving the second indication;
monitor rate oscillation based at least in part upon the first hotel rate;
determine whether a second hotel rate is less than the first hotel rate;
facilitate a second hotel reservation in response to determining that the second hotel rate is less than the first hotel rate;
communicate a message to the user in response to facilitating the second hotel reservation, the message containing a request to choose one of the first hotel reservation and the second hotel reservation;
cancel the first hotel reservation in response to determining that the user has selected the second hotel reservation; and
cancel the second hotel reservation in response to determining that the user has selected the first hotel reservation.

16. The web server of claim 15, wherein determining the hotel cluster comprises:
determining a geographical location of the first hotel;
determining a hotel quality rating of the first hotel; and
determining at least one hotel based at least in part upon the geographical location and the hotel quality rating.

17. The web server of claim 15, further operable to cease rate oscillation monitoring if the cancellation threshold has been exceeded.

18. The web server of claim 15, wherein monitoring rate oscillation comprises retrieving a plurality of hotel rates based at least in part upon the hotel cluster.

19. The web server of claim 18, wherein the plurality of hotel rates are retrieved at a predetermined time.

20. The web server of claim 15, wherein determining whether the second hotel rate is less than the first hotel rate comprises determining whether the difference between the second hotel rate and the first hotel rate is greater than a savings threshold.

21. The web server of claim 15, further operable to:
receive a third indication that the user has selected a hotel option; and
alter the hotel cluster based at least in part upon the hotel option.
